(19) United States
(12) Patent Application Publication
(10) Pub. No.: US 2010/0252600 A1
(43) Pub. Date: Oct. 7, 2010

(54) ADHESIVE TAPE DISPENSING DEVICE

(76) Inventor: CHI-TSAI CHANG, Taichung City (TW)

Correspondence Address: LEONG C LEI, PMB # 1008, 1867 YGNACIO VALLEY ROAD, WALNUT CREEK, CA, 94598, US

(21) Appl. No.: 12/416,167

(22) Filed: Apr. 1, 2009

(51) Int. Cl. B26F 3/02

(52) U.S. Cl. 225/77

(57) ABSTRACT

The adhesive tape dispensing device contains a body having at least a tray with a lateral pivot along a front bottom edge of the body, and at least a tape holder having at least a front side, a lateral through groove along a front bottom corner, a lateral blade along a front top corner, a lateral axle for holding a roll of adhesive tape, and a concave between the front side and the axle. Each tape holder is removably attached to the pivot by embedding the pivot to the through groove. Each tape holder is capable of rotating forward to facilitate access and cut-off to tapes and of rotating backward about the pivot to restore original position.

### TECHNICAL FIELD OF THE INVENTION

The present invention generally relates to adhesive tape dispensing devices, and more particularly to an adhesive tape dispensing device having one or more tape holders that could be independently and individually tilted for easy access to the tapes.

### DESCRIPTION OF THE PRIOR ART

Most conventional adhesive tape dispensing devices, be it stationary ones for the desktop or portable ones, have their adhesive tape rolls exposed. For example, as shown in FIG. 9, a small portable adhesive tape dispensing device has a body 20 which contains two identical and parallel vertical pieces connected by a lateral bottom plate. Along a front edge of the bottom plate, a saw-tooth blade 21 is provided. On the two vertical pieces' opposing surfaces, protrusions are provided to jointly form an axle for a roll of tape 22. When the tape is pulled out of the roll 22, it could be cut off by the blade 21. As could be easily seen, the tape dispensing device has an open structure and, as such, the most troublesome problem of the tape dispensing device is that, without adequate protection, the adhesive tape is easily contaminated. This kind of design is not appropriate at where a high standard of hygiene is required. FIGS. 10 and 11 show another conventional tape dispensing device capable of accommodating multiple rolls of different colored tapes. As illustrated, the tape dispensing device contains a box casing 30 having an open right side and a lateral axle 31 inside extending from a left side to the open right side. A number of rolls of tapes 32, separated by padding rings 33 between adjacent rolls 32, are threaded by the axle 31 and a cover 34 seals the open right side of the casing 30. A lateral slot 36 is formed along a front side of the casing 30 so that the tapes from the rolls 32 could be pulled out of the casing 30 and cut off by a lateral blade 35 in front of the slot 36. The front side of the casing 30 across the slot 36 has a roughened surface 37 to facilitate the attachment of the pulled out tape. This design has a number of problems. For example, if one of the rolls in the middle has running out of tapes, all the rolls on one side of the exhausted roll have to be taken out so as to install a new one if the original color arrangement has to be preserved. Also the tapes being cut off are those section that are already exposed and attached to the roughened surface 37, which could very possible be contaminated already.

### SUMMARY OF THE INVENTION

Due to the foregoing shortcomings of the conventional tape dispensing devices, the present invention provides a novel tape dispensing device where a lateral pivot is provided. Then, a number of rolls of tapes could be removably attached to the pivot and each of these rolls could rotate about the pivot individually and independently. Therefore, to access a particular tape, only the corresponding roll is rolled out and accessed. And, if any one roll has run out of tape, only that particular roll is replaced without interfering all other rolls.

Another major purpose of the present invention is to provide a tape dispensing device where a protective casing is used to house one or more rolls of tapes when they are not in use. The blades for shearing the tapes and the tapes themselves are all housed inside the casing. Together with the provision of the pivot, the rolls of tapes could be conveniently and separately tilted out of the casing for access. After usage, the rolls could be restored inside the casing for enhanced safety and hygiene.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of a tape dispensing device according to a first embodiment of the present invention.

FIG. 2 is a perspective diagram showing the tape dispensing device of FIG. 1 after its assembly.

FIG. 3 is a schematic profile diagram showing an operation scenario of the tape dispensing device of FIG. 1.

FIG. 4 is a perspective break-down diagram showing the various components of a tape dispensing device according to a second embodiment of the present invention.

FIG. 5 is a schematic profile diagram showing the tape dispensing device of FIG. 4.

FIG. 6 is a schematic profile diagram showing an operation scenario of the tape dispensing device of FIG. 4.

FIG. 7 is a perspective break-down diagram showing the various components of a tape dispensing device according to a third embodiment of the present invention.

FIG. 8 is a perspective diagram showing the tape dispensing device of FIG. 7 after its assembly.

FIG. 9 is a perspective diagram showing a conventional tape dispensing device.

FIG. 10 is a perspective break-down diagram showing the various components of another conventional tape dispensing device supporting multiple tapes.

FIG. 11 is a perspective diagram showing the conventional tape dispensing device of FIG. 10 after its assembly.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

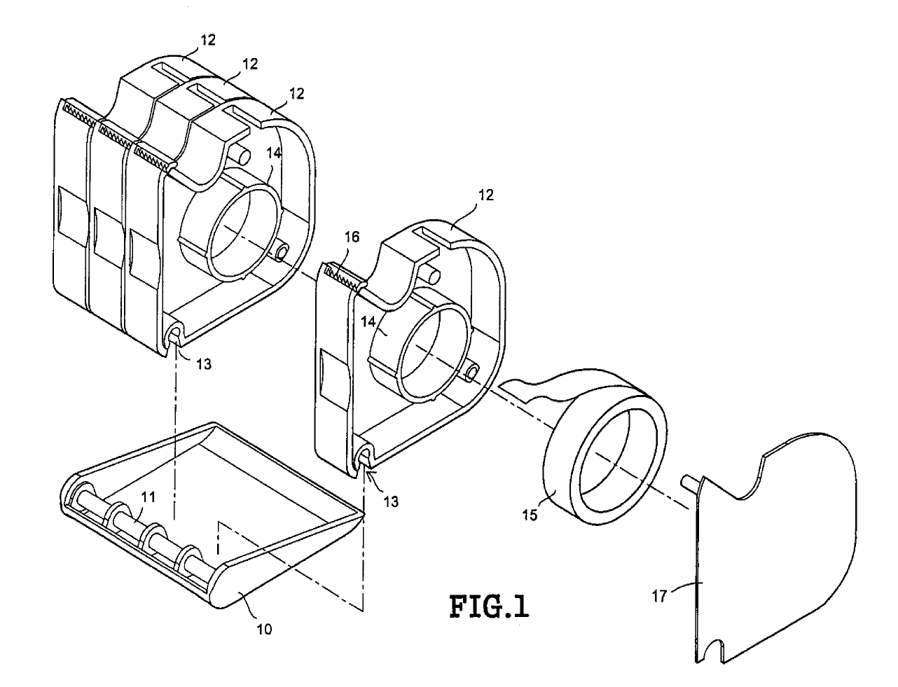

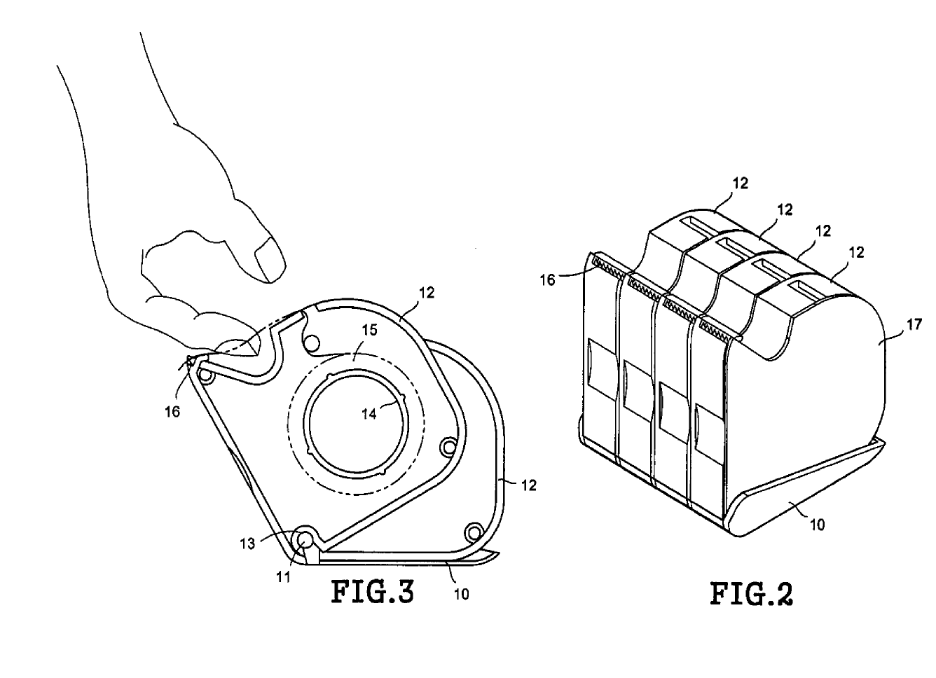

As shown in FIGS. 1 to 3, a tape dispensing device according to a first embodiment of the present invention contains a rectangular support tray 10 with two lateral walls and a back wall. Along a front edge of the support tray 10, a pivot 11 is provided between the lateral walls. The support tray 10 allows one or more tape holders 12 to be placed thereon. Each tape holder 12 has a substantial box shape with an open right side. A bottom side wall of each tape holder 12 surrounds a lateral through groove 13 at a front lower corner of the tape holder 12. By snapping the pivot 11 into the channel 13, the tape holder 12 is able to rotate about the pivot 11. In the center of each tape holder 12, a ring wall 14 is provided for the installation of a roll of tape 15. At a front upper corner of each tape holder 12, a blade 16 for shearing the tape is provided. Alternatively, a saw-tooth edge could be integrally formed there on the side wall for tape cut-off. After a number of tape holders 12 are placed on the support tray 10, a right cover plate 17 seals the right side of the rightmost tape holder 12, as shown in FIG. 2. Please note that a top side wall of each tape holder 12 and a top edge of the right cover plate 17 have a concaved section behind the blades 16 for easy access to the tape. As shown in FIG. 3, each tape holder 12 is able to pivot around the pivot 11 for an angle to facilitate the tape cut-off and application. After the tape is cut off, the tape holder 12 could be restored to its original position on the support tray 10.

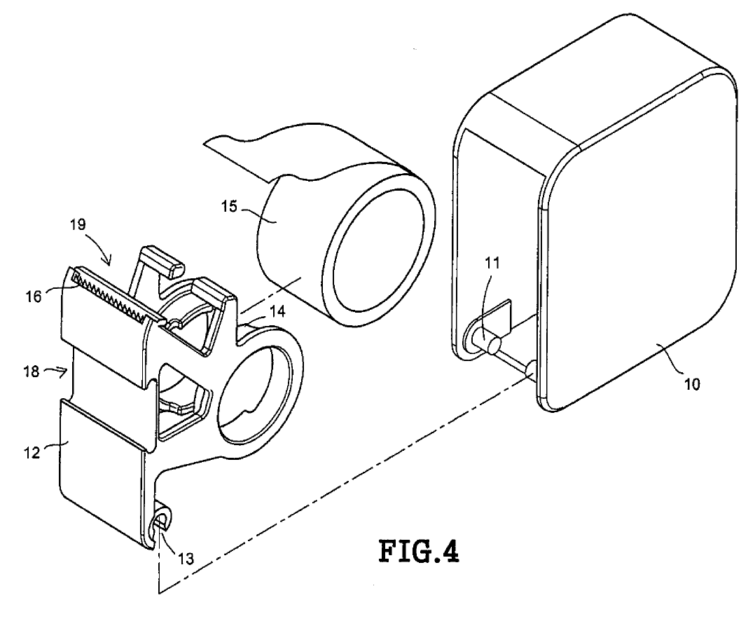

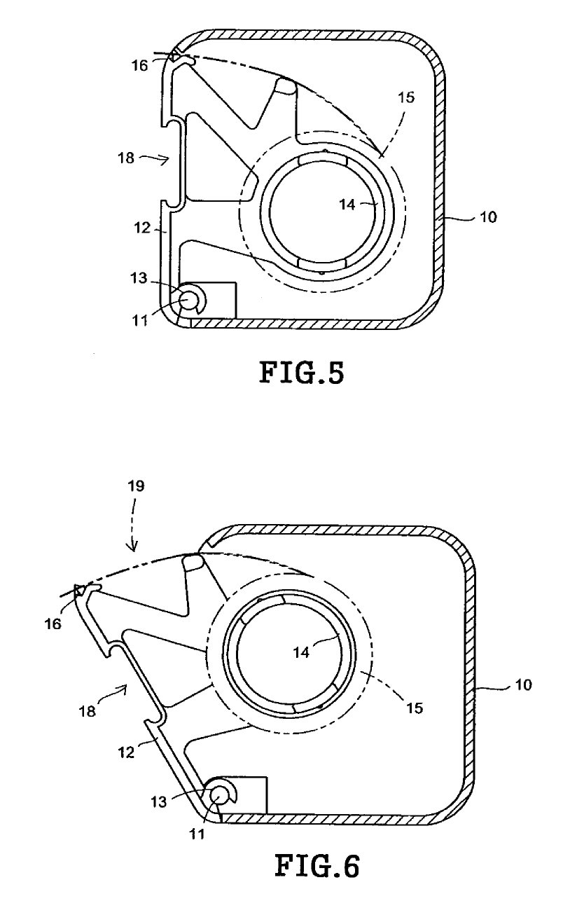

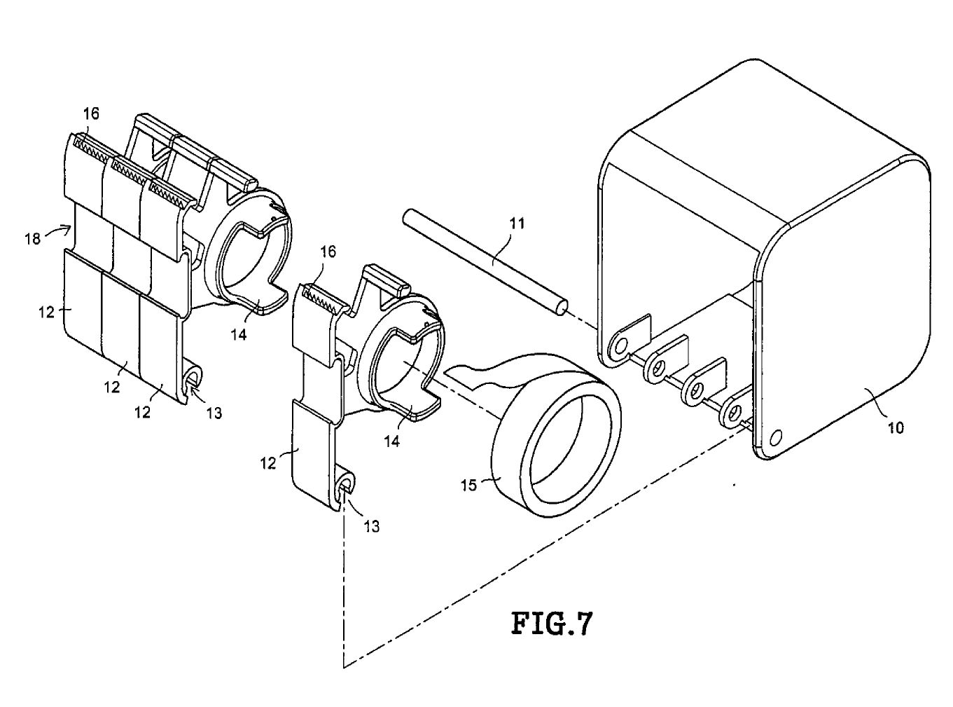

As shown in FIGS. 4 to 6, a second embodiment of the present invention uses a box-shaped casing 10 with at least an open front side, instead of a support tray, to house a tape holder 12. Similar to the previous embodiment, a pivot 11 is provided at a front lower corner of the casing 10 for embedding into a lateral through groove 13 of the tape holder 12. In the present embodiment, the tape holder 12, instead of a box shape, has a simplified open frame structure with a front plate with a C-shaped lateral indentation 18 and a left side wall. This indentation 18 is to facilitate the flipping out of a tape holder 12. A blade 16 is also provided at a front top corner of the tape holder 12. A ring wall 14 is extended from the left side wall to support a roll of tape 15 behind the front plate. The tape then could be extended to the blade 16 for cut-off. A concaved section 19 is provided along a top edge on the left side wall adjacent to the blade 16 for easy access to the tape. Again, the tape holder 12 is able to pivot around the pivot 11 for an angle to facilitate the tape cut-off and application. After the tape is cut off, the tape holder 12 could be restored inside the casing 10. As such, the sharp blade 16 is concealed and the tape is prevented from contamination. The tape dispensing device of the present invention therefore has an enhanced level of operational safety and hygiene.

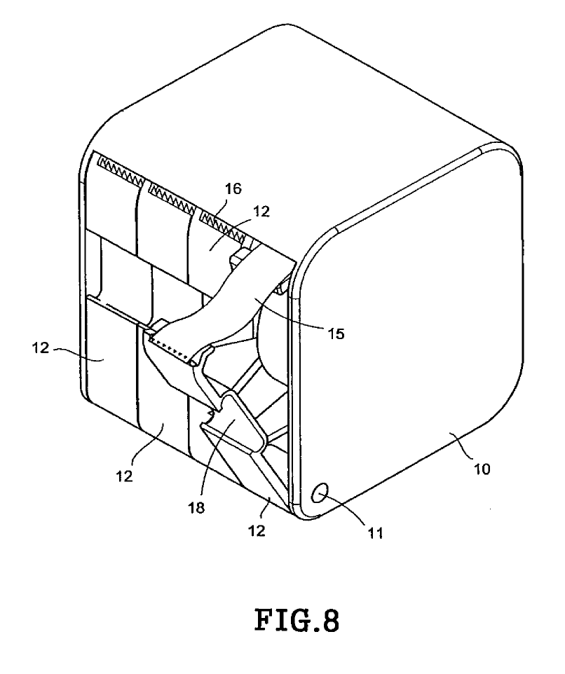

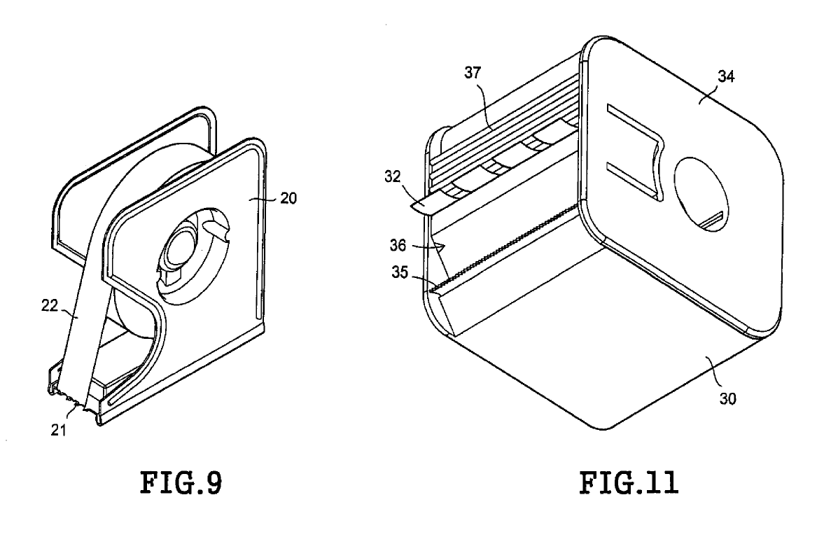

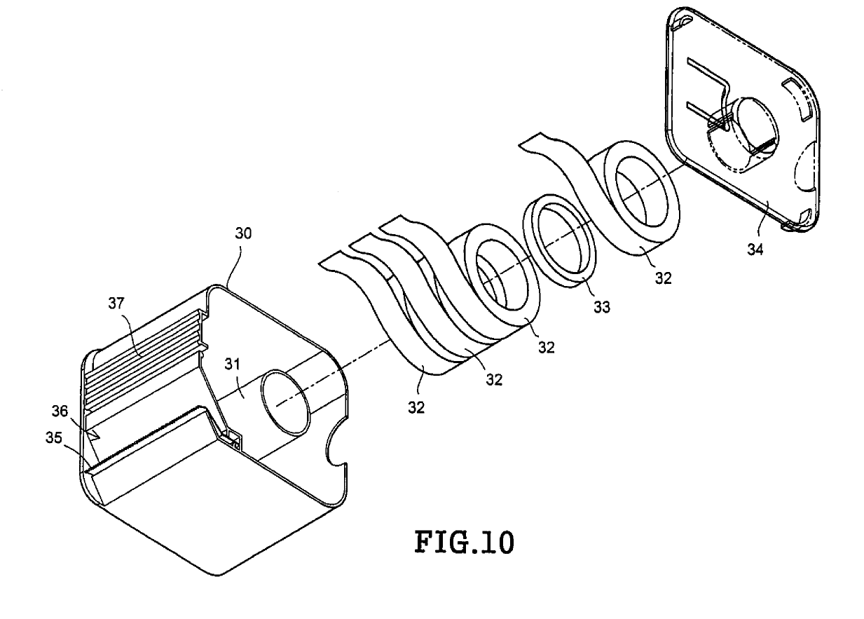

As shown in FIGS. 7 and 8, a third embodiment of the present invention is an extension of the previous embodiment, where the casing 10 is enlarged laterally to accommodate multiple tape holders 12 with different colored tapes. These tape holders 12 all attach to the pivot 11 and could be independently and individually removed and installed. Their tapes could also be accessed separately by tilting the right tape holder 12 out of the casing 10. The tape holders 12 do not interfere with other and will not render any difficulty to the access of any one tape. Similar to the previous embodiment, the sharp blades 16 are all concealed inside the casing 10 and the tapes are prevented from contamination. Due to the enhanced safety and hygiene, the present invention is especially suitable for the adhesive tapes used in medical facilities where the tape dispensing device could be carried by the medical personnel and the tapes will not be exposed until they are actually tilted outside the casing 10 and accessed.

In the foregoing embodiments, the tape holders 12 are of an identical design. For the second and third embodiments where the tape holders 12 are entirely housed inside the casing 10, their structure is simplified to an open frame. This makes the present invention even lighter to carry and the production cost is reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An adhesive tape dispensing device, comprising:
a body having at least a tray with a lateral pivot along a front bottom edge of said body; and
at least a tape holder having at least a front side, a lateral through groove along a front bottom corner, a lateral blade along a front top corner, a lateral axle for holding a roll of adhesive tape, and a concave between said front side and said axle;
wherein each tape holder is removably attached to said pivot by embedding said pivot to said through groove; each tape holder is capable of rotating forward to facilitate access and cut-off to tapes and of rotating backward about said pivot to restore original position.

2. The adhesive tape dispensing device according to claim 1, wherein said blade is a saw-tooth edge integrally formed with said front side of said tape holder.

3. The adhesive tape dispensing device according to claim 1, wherein said tape holder further has a lateral side where said lateral axle is extended from.

4. The adhesive tape dispensing device according to claim 1, wherein said body is a casing having at least a front opening.

5. The adhesive tape dispensing device according to claim 1, wherein said front side of each tape holder has a C-shaped lateral indentation for flipping and rotating said tape holder.
